(19) United States
(12) Patent Application Publication
(10) Pub. No.: US 2025/0360695 A1
(43) Pub. Date: Nov. 27, 2025

(54) RECYCLABLE FILMS FOR PRODUCT PACKAGING

(71) Applicant: AMCOR FLEXIBLES NORTH AMERICA, INC., Neenah, WI (US)

(72) Inventors: Ross K. GRUETZMACHER, Neenah, WI (US); Ankush A. GOKHALE, Fulshear, TX (US)

(21) Appl. No.: 18/873,668

(22) PCT Filed: Jun. 20, 2022
(86) PCT No.: PCT/US2022/034162

§ 371 Date: Dec. 10, 2024

(51) Int. Cl. B32B 27/08; B32B 27/20; B32B 27/32

(52) U.S. Cl. CPC B32B 27/08; B32B 27/20; B32B 27/32; B32B 2250/242; B32B 2307/306; B32B 2307/518; B32B 2439/70

(57) ABSTRACT

A polyethylene-based packaging film having an outer surface and an inner surface. The polyethylene-based packaging film includes an oriented coextruded film that includes a first region connected to a second region. The first region includes a first polyethylene, has a first region thickness, and forms the outer surface of the polyethylene-based packaging film. The second region includes a second polyethylene and an antioxidant, and has a second region thickness. A third region is laminated to the second region and includes a sealant film. A thickness ratio of the first region thickness to the second region thickness is in a range of from 1:99 to 50:50. The polyethylene-based packaging film includes a gel content of less than 3% according to test method ASTM D2765-01, Method C.

### TECHNICAL FIELD

The present disclosure relates to polyethylene-based packaging films that may be used as primary packaging for products such as food or beverage. The films may be considered recyclable and have improved heat resistance properties. Packages made from the films and methods to make the films are also provided.

### BACKGROUND

Stand-up pouches (SUP) for flexible packaging and other flexible film packages often use oriented polyethylene terephthalate (OPET) or biaxially-oriented nylon (BON) for outer film layers, which provide high stiffness, printing quality and heat resistance. Without any additional compatibilizing chemicals, however, neither OPET nor BON are recyclable in current flexible polyethylene recycling streams.

Utilizing recyclable flexible packaging is a goal for many consumers and food packagers. Recyclable SUP structures are desirable for compliance purposes. It is understood that a polyethylene (PE) structure is a way to provide recyclable films. PE structures typically have low stiffness and limited heat resistance. To improve the initial low stiffness and heat sealing performances of PE, some PE films of the prior art are machine direction-oriented. For example, the maximum heat resistance is limited to the melting temperature of the film outer PE layer. For a polymer such as high density polyethylene (HDPE), the heat resistance is thus limited at 132 degrees Celsius (° C.) (270 degrees Fahrenheit (° F.)), which is considered to be low heat resistance. Low heat resistance affects package production efficiency due to lower machine speeds that are necessary to achieve sufficient heat transfer to a sealant layer of the flexible packaging film.

Irradiating (e.g., electron beam cross-linking, E-beam, etc.) PE flexible packaging films is also known to increase film heat resistance. However, irradiation of the PE flexible packaging films is also known to negatively affect the recyclability of the film due to excessive gel formation (e.g., gel content, gel fraction).

### SUMMARY

The present disclosure relates to a polyethylene-based flexible packaging film that includes improved heat resistance due to targeted cross-linking in the outer surface. The polyethylene-based flexible packaging film may be recycled in a polyethylene-based recycling stream due to the inhibition of cross-linking in other portions of the film.

In a first embodiment, a polyethylene-based packaging film has an outer surface and an inner surface. The polyethylene-based packaging film comprises an oriented coextruded film comprising a first region connected to a second region. The first region comprising a first polyethylene, a first region thickness, and forming the outer surface of the polyethylene-based packaging film. The second region comprising a second polyethylene and an antioxidant, and a second region thickness. A third region being laminated to the second region and comprising a sealant film. A thickness ratio of the first region thickness to the second region thickness is in a range of from 1:99 to 50:50. The polyethylene-based packaging film includes a gel content of less than 3% according to test method ASTM D2765-01, Method C.

In a second embodiment, a polyethylene-based packaging film has an outer surface and an inner surface. The polyethylene-based packaging film comprises an oriented coextruded film comprising a first region connected to a second region. The first region comprising a first polyethylene comprising a cyclic olefin copolymer, a first region thickness, and forming the outer surface of the polyethylene-based packaging film. The second region comprising a second polyethylene and an antioxidant, and a second region thickness. A third region being laminated to the second region and comprising a sealant film. A thickness ratio of the first region thickness to the second region thickness is in a range of from 1:99 to 50:50. The polyethylene-based packaging film includes a gel content of less than 3% according to test method ASTM D2765-01, Method C.

In a third embodiment, a method of making a polyethylene-based packaging film may include operations of: connecting, irradiating, and laminating. For a connecting operation, in one or more embodiments, a first region is connected to a second region to form a connected first region and second region. The first region having a first region thickness may include a first polyethylene, and the second region having a second region thickness may include a second polyethylene and an antioxidant. For an irradiating operation, in one or more embodiments, the connected first region and second region are irradiated with a dosage of from equal to or greater than 6 Megarads (Mrad). For a laminating operation, a third region is laminated to the second region. In one or more embodiments, an exposed surface of the polyethylene-based packaging film comprises the first region. The polyethylene-based packaging film may include a thickness ratio of the first region thickness to the second region thickness of from 1:99 to 50:50. The polyethylene-based packaging film comprises a gel content from less than 3% according to test method ASTM D2765-01, Method C.

Other features that may be used individually or in combination with respect to the first embodiment are as follows.

The first polyethylene may include polyethylene homopolymers, ethylene copolymers, alpha-olefin polyethylene copolymer, or blends thereof.

The first polyethylene may include high density polyethylene (HDPE).

Another feature that may be used in combination with respect to the third embodiment includes an orienting step that includes orienting the connected first region and second region that occurs before the irradiating step.

Other features that may be used individually or in combination with respect to any embodiment are as follows.

The first region and the second region may be connected directly to each other.

A tie layer may be positioned between the first region and the second region.

The first region and the second region may include a biaxially oriented film.

The first region and the second region may include a monoaxially oriented film.

The antioxidant may be present in an amount from 1.5% to 5.0%, by weight of the polyethylene-based packaging film.

The second region may include a multilayer coextruded film.

The second polyethylene may include polyethylene homopolymers, ethylene copolymers, alpha-olefin polyethylene copolymer, cyclic olefin copolymer, or blends thereof.

The first antioxidant may include a primary antioxidant, a secondary antioxidant, or a combination thereof.

The polyethylene-based packaging film may include a thermal resistance from 127 degrees Celsius (° C.) (260 degrees Fahrenheit (° F.)) to 152° C. (305° F.).

The polyethylene-based packaging film may include a Shrinkage Value of 10% or less upon application of heat equal to 90° C.

The polyethylene-based packaging film may be a polyethene-rich packaging film.

In a fourth embodiment, a package includes any of the polyethylene-based packaging films disclosed herein.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of a first region of a polyethylene-based packaging film;

FIG. 2 illustrates a schematic cross-sectional view of another embodiment of a first region of a polyethylene-based packaging film;

FIG. 3 illustrates a schematic cross-sectional view of an embodiment of a second region of a polyethylene-based packaging film;

FIG. 4 illustrates a schematic cross-sectional view of another embodiment of a second region of a polyethylene-based packaging film;

FIG. 5 illustrates a schematic cross-sectional view of an embodiment of a third region of a polyethylene-based packaging film;

FIG. 6 illustrates a schematic cross-sectional view of another embodiment of a third region of a polyethylene-based packaging film;

FIG. 7 illustrates a schematic cross-sectional view of an embodiment of a polyethylene-based packaging film;

FIG. 8 illustrates a schematic perspective view of an embodiment of a package formed from an embodiment of a polyethylene-based packaging film;

FIG. 9 illustrates a schematic perspective view of an embodiment of a packaged product in the package shown in FIG. 8; and

FIG. 10 illustrates a flowchart depicting method steps of making a polyethylene-based packaging film in accordance with an embodiment of the present disclosure.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are polyethylene-based packaging films, packages produced from the films, and methods of producing the films. The polyethylene-based packaging films include a first region, a second region and a third region. The films include irradiative cross-linking and may be oriented. The films exhibit limited shrinkage upon exposure to heat sealing conditions.

High heat resistance of the disclosed films allows for better converting on existing heat sealing machines. It is understood that there is an approximate 10° C. (15° F.) difference of any given commercial heat sealing process due to variability of the thermostats that control heat bars of the heat sealing machines. The heat resistance of the disclosed polyethylene-based packaging films can tolerate the heat bar temperature variability better than current films. The polyethylene-based packaging films have the distinct advantage of demonstrating improved heat resistance and may be more readily recyclable in a single polymer recycling stream (e.g., polyethylene) because of low gel content.

A “film”, as used herein, refers to a monolayer or multilayer web that has an insignificant z-direction dimension (thickness) as compared to the x- and y-direction dimensions (length and width). Films are generally regarded as having two major surfaces, opposite each other, expanding in the length and width directions. The surface of the film that is not connected to another layer or film is an exposed surface of the film. Films may be built from an unlimited number of films, layers, or films and layers with the films and/or layers being bonded together to form a multilayer film.

A “layer”, as used herein, refers to a building block of sidewalls that is a structure of a single polymer-type or a blend of polymers. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single film structure, which may have a plurality of layers, generally in the form of a sheet or web that can be made from a polymeric material or a non-polymeric material bonded together by any conventional means known in the art, (i.e., coextrusion, lamination, coating, or a combination thereof). The multilayer films described herein may include at least any of the following numbers of layers: 2, 3, 4, 5, 6, 7, 8, 9, 10, 11, 12, 13, 14, and 15.

A “region”, as used herein, refers to a building block of a multilayer film. A region may be a monolayer film that is a portion of a multilayer film. A region may be a multilayer film that is a portion of another multilayer film.

Reference to the terms “outer surface”, “outer layer”, or “outer film”, as used herein, refer to the portion of a package that is located outermost of all the surfaces, layers, regions, or films respectively of the package.

Reference to an “inner surface”, as used herein, refers to the surface of a layer or film away from the outer surface and towards the interior where the product is packaged.

An “inner layer”, as used herein, refers to a layer that is not exposed to handling and the environment. Inner layers may provide functionality as needed for particular applications. Inner layers generally allow for thermoforming of the entire film. In addition, inner layers may provide barrier protection or structural strength. An exemplary inner layer includes a barrier layer, which provides protection to packaged food for freshness, or a barrier to moisture or oxygen. Barrier layers may also protect outer films, layers, or regions from migration from package contents (e.g., oils and the like). An exemplary inner layer may also be a structural layer, which provides one or more of general durability, puncture strength, resistance to curling, and flex crack resistance.

As used herein, the term “polymer” refers to the product of a polymerization reaction, and is inclusive of homopolymers, copolymers, terpolymers, etc. In general, the layers of a film can consist essentially of a single polymer, or can have still additional polymers together therewith, i.e., blended therewith.

As used herein, the term “copolymer” refers to polymers formed by the polymerization of reaction of at least two different monomers. As used herein, a copolymer identified in terms of a plurality of monomers, e.g., “propylene/ethylene copolymer”, refers to a copolymer in which either monomer may copolymerize in a higher weight or molar percent than the other monomer or monomers. However, the first listed monomer preferably polymerizes in a higher weight percent than the second listed monomer.

As used herein, terminology employing a “/” with respect to the chemical identity of a copolymer (e.g., propylene/ethylene copolymer), identifies the comonomers that are copolymerized to produce the copolymer.

The terms “tie layer”, “adhesive layer”, or “adhesive coating”, as used herein, refer to a material placed on one or more layers or regions, partially or entirely, to promote the adhesion of that layer or region to another surface. Preferably, adhesive layers or coatings are positioned between two layers or two regions of a multilayer film to maintain the two layers or two regions in position relative to each other and prevent undesirable delamination. Unless otherwise indicated, a tie layer or an adhesive layer or coating can have any suitable composition that provides a desired level of adhesion with the one or more surfaces in contact with the adhesive layer material.

A “sidewall” is a discrete piece of polymer film or multilayer laminate that is sealed to itself or another sidewall by, for example, welding or an adhesive, to form a pouch or a bag.

The term “heat sealing conditions”, as used herein, refers to residence time and temperature that are suitable for a sealant layer or sealant surface to adhere to itself.

As used herein, the term “cross-linking” refers to the chemical reaction which results in the formation of bonds between polymer chains, such as, but not limited to, carbon-carbon bonds. Cross-linking may be accomplished by use of a chemical agent or combination thereof which may include, but is not limited to, for example, peroxide, silanes and the like, and ionizing radiation, which may include, but is not limited to, high energy electrons, gamma-rays, beta particles and ultraviolet radiation. The irradiation source can be any electron beam generator operating in a range of about 150 kilovolts to 6,000 kilovolts (6 megavolts) with a power output capable of supplying the desired dosage. The voltage can be adjusted to appropriate levels, which may be, for example, 1 million to 6 million volts, or may be higher or lower. Many apparatus for irradiating films are known to those skilled in the art. In general, the most preferred amount of radiation is dependent upon the film structure and its total thickness. One method for determining the degree of “cross-linking” (e.g., “cross-link density”) or the amount of radiation absorbed by a material is to measure the “gel content”. As used herein, the term “gel content” refers to the relative extent of cross-linking within a polymeric material. Gel content is expressed as a relative percent (by weight) of the polymer having formed insoluble carbon-carbon bonds between polymers and may be determined by test method ASTM D-2765-01, Method C, which is incorporated herein by reference in its entirety. Another method for determining the relative degree of cross-linking or gel content is with capillary viscometry. The apparent shear viscosity of the polymer is measured with respect to the apparent shear rate of the polymer. This measured result is representative of the relative degree of cross-linking because it is known that viscosity increases as the level of cross-linking increases.

### Polyethylene-Based Packaging Film

The term “polyethylene-based”, as used herein, refers to an article (e.g., a package, a film, a layer, a region, etc.) that includes high levels of polyethylene polymer. In some cases, a polyethylene-based article includes at least 50% polyethylene polymers, by weight. A polyethylene-based article may have at least 60%, at least 70%, at least 80%, at least 90%, at least 95%, or any range or combination of ranges therein of polyethylene polymers, by weight. In some cases, a polyethylene-based article consists of polyethylene polymers (i.e., 100%, by weight). The article may be accompanied by other minor components such as slip, anti-block, processing aid, nucleation additives, or hydrocarbon additives, for example.

In some cases, the polyethylene-based article consists of polyethylene polymers and the article is considered to be polyethylene-rich. The term “polyethylene-rich” refers to an article (e.g., a package, a film, a layer, a region, etc.) that includes very high levels of polyethylene polymers. In some cases, a polyethylene-rich article has at least 90% polyethylene polymers, by weight. For example, the polyethylene-rich article may have at least 92%, at least 94%, at least 96%, at least 98%, 100%, or any range or combination of ranges therein of polyethylene polymers, by weight.

As used herein, the term “polyethylene polymer” refers to a polymer that possesses ethylene linkages, maintains a glass transition temperature below 50° C. and whose basic structure is characterized by the chain —(CH₂—CH₂—)n. The polymer may be a homopolymer of ethylene or a copolymer of ethylene and other monomers. Polyethylene homopolymer is generally described as being a solid which has a partially amorphous phase and partially crystalline phase with a density of between 0.915 g/cm³ to 0.970 g/cm³. The relative crystallinity of polyethylene is known to affect its physical properties. The amorphous phase imparts flexibility and high impact strength while the crystalline phase imparts a high softening temperature and rigidity. Examples of polyethylene polymers include but are not limited to low-density polyethylene (LDPE), high-density polyethylene (HDPE), ethylene/alpha-olefin copolymer (EAO), linear low-density polyethylene (LLPDE), metallocene-catalyzed linear-low density polyethylene (mLLDPE), ethylene-vinyl acetate copolymer (EVA), cyclic olefin copolymers (COC) (e.g., ethylene/norbornene copolymer), ethylene/alkyl acrylate copolymer, ethylene/(meth)acrylic acid copolymer, ionomer resin, and maleic anhydride grafted polyethylene (MAH-PE).

As used throughout this disclosure, the term “ethylene/norbornene copolymer” refers to a class of polymeric materials based on cyclic olefin monomers and ethane. Ethylene/norbornene copolymers are known commercially as cyclic olefin copolymers, “COC”, with one or more different cyclic olefin units randomly or alternately attached to the ethylene polymer backbone. In general, COCs exhibit a relatively high glass transition temperature (greater than 50° C.), optical clarity, low heat shrinkage, low moisture absorption, and low birefringence. Ethylene/norbornene copolymer may have a norbornene content greater than 20 mol %.

“High density” polyethylene (HDPE) is ordinarily used in the art to refer to both (a) homopolymers of densities between about 0.960 g/cm³ to 0.970 g/cm³ and (b) copolymers of ethylene and an alpha-olefin having densities between 0.940 g/cm³ and 0.958 g/cm³. HDPE includes high molecular weight “polyethylenes.”

In contrast to HDPE, whose polymer chain has some branching, are “ultra high molecular weight polyethylenes,” which are essentially unbranched, specialty polymers having a much higher molecular weight than the high molecular weight HDPE. Ultra high molecular weight polyethylene includes a density from 1.12 g/cm³ to 1.24 g/cm³.

“Medium density” polyethylene (MDPE) typically has a density from 0.928 g/cm³ to 0.940 g/cm³.

Another grouping of polyethylene is “high pressure, low density polyethylene” (LDPE). LDPE is used to denominate branched homopolymers having densities between 0.915 g/cm³ and 0.930 g/cm³. LDPEs typically include long branches off the main chain (often termed “backbone”) with alkyl substituents of 2 to 8 carbon atoms.

“Ethylene/alpha-olefin copolymer” (EAO), as used herein, refers to copolymers of ethylene with one or more comonomers selected from C₃ to C₁₀ alpha-olefins and includes such heterogeneous materials as linear medium density polyethylene (LMDPE), linear low density polyethylene (LLDPE), very low and ultra low density polyethylene (VLDPE and ULDPE), homogeneous ethylene/alpha olefin copolymers (HEAO), and multicomponent ethylene/alpha-olefin interpenetrating network resin.

“Linear low density” polyethylene (LLDPE) includes copolymers of ethylene with alpha-olefins having densities from 0.915 g/cm³ to 0.940 g/cm³. The alpha-olefin utilized is usually 1-butene, 1-hexene, or 1-octene and Ziegler-type catalysts are usually employed (although Phillips catalysts are also used to produce LLDPE having densities at the higher end of the range and metallocene and other types of catalysts are also employed to produce other well-known variations of LLDPEs). A LLDPE produced with a metallocene or constrained geometry catalyst is often referred to as “mLLDPE”.

A polyethylene-based packaging film, as disclosed herein, is a multilayer film having a first region, a second region, and a third region.

The first region includes a first polyethylene. The first polyethylene may include, but is not limited to, LDPE, MDPE, HDPE, ultra high molecular weight polyethylene, EAO, HEAO, LLPDE, mLLDPE, LMDPE, VLDPE, ULDPE, EVA, COC, ethylene/alkyl acrylate copolymer, ethylene/(meth)acrylic acid copolymer, ionomer resin, MAH-PE, and combinations thereof.

The first region may be a monolayer or a multilayer film. The first region includes a first surface and a second surface. The first surface is an outer surface of the polyethylene-based packaging film that is exposed to handling and the external package environment. The second surface of the first region includes an inner surface of the polyethylene-based packaging film. In an embodiment where the first region is a monolayer film, the monolayer film includes the first surface and the second surface of the first region. In an embodiment where the first region includes a multilayer film, for example, a first region first layer and a first region second layer, the first region first layer includes the first surface of the first region that is an outer surface of the polyethylene-based packaging film. The first region second layer includes the second surface of the first region. Any number of inner layers may be provided between the first region first layer and the first region second layer in a multilayer first region embodiment. In an embodiment, a multilayer first region may be a coextruded film.

The second region includes a second polyethylene and an antioxidant. The second polyethylene may include, but is not limited to, LDPE, MDPE, HDPE, ultra high molecular weight polyethylene, EAO, HEAO, LLPDE, mLLDPE, LMDPE, VLDPE, ULDPE, EVA, COC, ethylene/alkyl acrylate copolymer, ethylene/(meth)acrylic acid copolymer, ionomer resin, MAH-PE, and combinations thereof. In an embodiment, the second polyethylene may be the same as the first polyethylene. In another embodiment, the second polyethylene may be different from the first polyethylene.

Antioxidants are known to provide light stability to polyethylene films by preventing discoloration or degradation of the films. The inventors of the present disclosure have unexpectedly discovered that the addition of antioxidants to the second region allows cross-linking to be localized at the outer surface (i.e., first region first surface) of the polyethylene-based packaging film and to be minimized elsewhere, upon irradiation of the first and second region. The cross-linked first region provides increased heat resistance to the outer surface of the polyethylene-based packaging film. The minimization of cross-linking in the remainder of the irradiated first region and second region may allow for more easily recyclable films due to low gel content in the polyethylene-based packaging film. The added antioxidant of the second region may allow the polyethylene-based packaging film to have a gel content of 3% or less. The gel content may be 3%, 2%, 1%, 0%, or any range or combination of ranges therein, when measured according to ASTM D2765-01, Method C.

The antioxidant may include a primary antioxidant, a secondary antioxidant, or a combination thereof. Primary antioxidants are often used for capturing generated radicals (e.g., scavenging oxygen or free radicals). Nonlimiting examples of primary antioxidants include phenolic antioxidant, hindered phenol antioxidants, amine antioxidant, and hindered amine antioxidant. Exemplary primary antioxidants include (a) POLYBATCH XAO 25B that is a butylated hydroxytoluene (BHT) antioxidant masterbatch, available from LyondellBassel, Houston, TX, USA, and (b) phenolic antioxidant available under the trade name of HOSTANOX available from Clariant Corporation, Bakersfield, CA, USA. Secondary antioxidants are often used for thermal stabilization of films to counter degradation resulting from high temperatures, long residence times, or reprocessing. Nonlimiting examples of secondary antioxidants include phosphorus antioxidant and sulfur antioxidant. An exemplary secondary antioxidant includes phosphorous antioxidant available under the trade name of HOSTANOX also available from Clariant Corporation.

In any embodiment, the second region includes the antioxidant added in an amount such that the polyethylene-based packaging film includes from 1.5% to 5.0% of antioxidant by weight of the polyethylene-based packaging film. While it is known that supplied polyethylene polymer resins may include from 0.1% to 0.25% of antioxidant by weight of the supplied resin, the amount of antioxidant added to the second region of the polyethylene-based packaging film is significantly higher than that of the amount in supplied resins. The improvements of the present disclosure are not seen with a supplied resin unless additional antioxidant is added in an amount that allows for the disclosed range in the polyethylene-based packaging film.

The second region may be a monolayer or a multilayer film. The second region includes a first surface and a second surface. The first surface is an outer surface of the second region that is connected to the second surface of the first region. The second surface is an outer surface of the second region that is connected to the third region. In an embodiment, the antioxidant may be present in a single layer when the second region is a monolayer film. In another embodiment, when the second region is a multilayer film, the antioxidant may be present in any, some, or all layers of the second region multilayer film.

In an embodiment where the second region is a monolayer film, the monolayer film includes the first surface and the second surface of the second region. In an embodiment where the second region includes a multilayer film, a second region first layer includes the first surface of the second region and a second region second layer includes the second surface of the second region. Any number of inner layers may be provided between the second region first layer and the second region second layer in a multilayer second region embodiment. In an embodiment, a multilayer second region may be a coextruded film.

The first region and the second region are connected by any coextrusion means known in the art. Coextrusion means may include blown and cast films that include the first and second regions. In an embodiment, the first region and the second region may be connected directly to each other and be devoid of any intervening layers. In another embodiment, the first region and the second region may be connected indirectly to each other with an intervening layer or layers positioned between the first and second regions. For example, a tie or adhesive layer, or adhesive coating may be positioned between the first region and the second region providing an indirect connection of the first and second regions. Adhesive compositions of the disclosure may include, but are not limited to, modified and unmodified polyolefins, preferably PE, most preferably, EAO copolymer, modified and unmodified acrylate resin, preferably selected from the group consisting of EVA copolymer, ethylene/ethyl acrylate copolymer, ethylene/butyl acrylate copolymer, or blends thereof.

The first region includes a first region thickness and the second region includes a second region thickness. The first region thickness may be less than the second region thickness. The first region thickness may be from 1.27 micron (0.05 mil) to 12.7 micron (0.50 mil). The first region thickness in this range is believed to avoid excessive gel content. The second region thickness may be from 12.7 micron (0.50 mil) to 50.8 micron (2.0 mil). A second region that includes a thickness greater than this range affects gel content such that recyclability may not be feasible. A thickness ratio of the first region thickness to the second region thickness may be in a range of from 1:99 to 50:50, or any ratio therein. For example, the thickness ratio of the first region thickness to the second region thickness may be in a range of from 5:95, 10:90, 20:80, 30:70, 40:60, or any ratio therein. In an embodiment, the second region thickness is greater than the first region thickness. In another embodiment, the second region thickness is equal to the first region thickness. In one or more embodiments, the second region thickness is greater than or equal to the first region thickness.

The connected first region and second region may be an oriented film. The term “oriented”, as used herein, refers to a film, sheet, web, etc., that has been elongated in at least one of the machine direction or the transverse direction. Such elongation is accomplished by procedures known in the art. Non-limiting examples of such procedures include a single bubble blown film extrusion process and a slot cast sheet extrusion process with subsequent stretching, for example, by tentering, to provide orientation. Machine direction orientation may be accomplished using nip rolls rotating at different speeds, pulling or drawing the film tube in the machine direction. In some embodiments, the first region and the second region are stretched in a single (e.g., machine) direction to include form a monoaxially oriented film. In other embodiments, the first region and the second region are stretched in both the machine and transverse directions to include a biaxially oriented film.

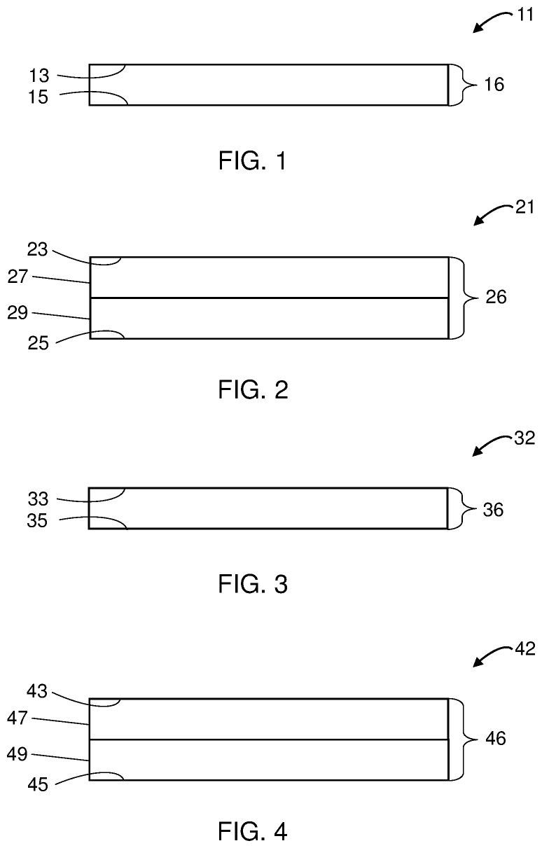

Turning to FIG. 1, an embodiment of a first region 11 is shown as a monolayer film. The first region 11 includes a first surface 13, a second surface 15, and a first region thickness 16. With reference to FIG. 2, an embodiment of a first region 21 is shown as a multilayer film that includes a first region first layer 27 and a first region second layer 29. The first region 21 includes a first surface 23 and a second surface 25. The first region 21 includes a first region thickness 26.

With reference to FIG. 3, an embodiment of a second region 32 is shown as a monolayer film. The second region 32 includes a first surface 33, a second surface 35, and a second region thickness 36. With reference to FIG. 4, an embodiment of a second region 42 is shown as a multilayer film that includes a second region first layer 47 and a second region second layer 49. The second region 42 includes a first surface 43 and a second surface 45. The second region 42 includes a second region thickness 46.

The polyethylene-based packaging film includes a third region that includes a sealant film. A “sealant film” includes at least one exposed sealant surface that is sealable to itself or another film to form a hermetic seal. The exposed sealant surface comprises a thermoplastic polymer or polymer mixture that softens when exposed to heat and returns to its original condition when cooled to room temperature.

In general, the third region may comprise any suitable thermoplastic material including, but not limited to, synthetic polymers such as polyesters, polyamides, polyolefins, polystyrenes, and the like. Exemplary polyolefins include polyethylene (PE) and polypropylene (PP). The third region can be made from materials considered to be recyclable.

The third region may be a monolayer or a multilayer film. The third region includes a first surface and a second surface. The third region first surface is an outer surface of the third region that is connected to the second surface of the second region. The third region second surface is an outer surface of the second region that is an exposed sealant surface.

In an embodiment where the third region is a monolayer film, the monolayer film includes the first surface and the second surface of the third region. In an embodiment where the third region includes a multilayer film, a third region first layer includes the first surface of the third region and a third region second layer includes the second surface of the third region. Any number of inner layers may be provided between the third region first layer and the third region second layer in a multilayer third region embodiment. The third region may include a thickness from 25.4 micron (1.0 mil) to 127 micron (127.0 mil). The thickness of the third region may allow for a higher ratio of the first region to the second region with respect to gel content. That is, the thicker the third region, the thicker the first region may be within the specified thickness ratio of the first region thickness to the second region thickness (i.e., from 1:99 to 50:50).

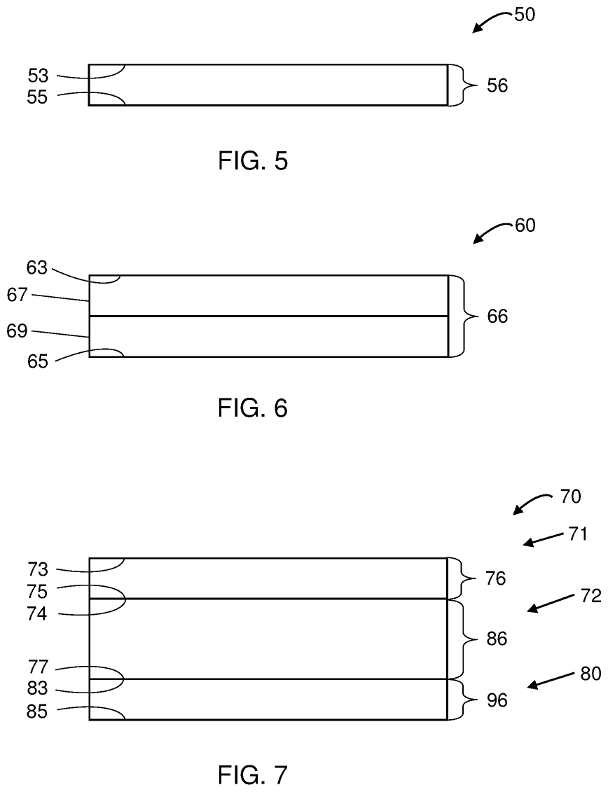

With reference to FIG. 5, an embodiment of a third region 50 is shown as a monolayer film. The third region 50 includes a first surface 53, a second surface 55, and a third region thickness 56. With reference to FIG. 6, an embodiment of a third region 60 is shown as a multilayer film that includes a second region first layer 67 and a second region second layer 69. In an embodiment that includes a multilayer third region, the third region 60 includes a first surface 63 and a second surface 65. The third region 60 includes a third region thickness 66.

The third region is laminated to the second region of the connected first region and second region, forming a polyethylene-based packaging film. With reference to FIG. 7, a polyethylene-based packaging film 70 is shown. The polyethylene-based packaging film 70 includes a first region 71, a second region 72, and a third region 80, where the first region 71, the second region 72, and the third region 80 may each be monolayer or multilayer films as previously described. The first region includes a first surface 73 and a second surface 75. The first region first surface 73 is an outer surface of the polyethylene-based packaging film 70. The second region 72 includes a first surface 74 and a second surface 77. The third region 80 includes a first surface 83 and a second surface 85. The first region 71 includes a first region thickness 76. The second region 72 includes a second region thickness 86. The third region 80 includes a third region thickness 96.

The third region first surface 83 is laminated to the second region second surface 77 by any lamination means known in the art (e.g., coextrusion, lamination, coating, printing, or a combination thereof). In an embodiment, the second region and the third region may be created and combined by way of a multilayer coextrusion process. The polyethylene-based packaging film 70 shown in FIG. 7 shows the second region 72 connected directly to the third region 80. This illustrates a coextrusion or thermal lamination of the second region 72 and the third region 80 because additional layers between the second region 72 and the third region 80 are not present. In another embodiment, the second region and the third region may be combined by way of lamination (e.g., adhesive lamination, polyethylene extrusion lamination).

The first region thickness 76 shown in FIG. 7 is substantially less than the second region thickness 86. The first region thickness 76 and the second region thickness 86 may each be any thickness as long as the thickness ratio of the first region thickness to the second region thickness falls within the range of from 1:99 to 50:50.

In some embodiments, the connected first region and second region may be oriented prior to being laminated to the third region. For example, some polyethylenes, such as HDPE, may benefit from being an oriented film to provide the stiffness, printing quality, optics (e.g., transparency, specular gloss, etc.), and heat resistance features sought after in a packaging film. Other polyethylenes, for example, COC, may be able to provide these features without being an oriented film. In an embodiment, the first region may include HDPE and the connected first and second region may be an oriented film. In another embodiment, the first region and the second region may each include HDPE and the connected first and second region may be an oriented film. In a further embodiment, the first region may include COC and the connected first and second region may not be an oriented film. In another embodiment, the first region and the second region may each include COC and the connected first and second region may not be an oriented film.

In some embodiments, the polyethylene-based packaging film may include a heat (e.g., thermal) resistance from 127° C. (260° F.) to 152° C. (305° F.). In other words, the polyethylene-based packaging film may be heat resistant to a temperature of at least about 127° C. In some embodiments, the heat resistance of the polyethylene-based packaging film may be equal to or greater than 130° C., equal to or greater than 140° C., or equal to or greater than 150° C.

The polyethylene-based packaging films further demonstrate limited shrinkage upon exposure to heat sealing conditions. Higher thermal resistance of the disclosed films allows for improved converting on existing heat sealing machines. The polyethylene-based film may have a Shrink Value of 10% or less upon application of heat equal to 90° C. The Shrink Value may be less than 10%, less than 9%, less than 8%, less than 7%, less than 6%, less than 5%, less than 4%, less than 3%, less than 2%, or less than 1%. The Shrink Value is defined to be values obtained by measuring unrestrained shrink at 90° C. for 5 seconds. Three test specimens are cut to 10 cm in the machine direction (MD) by 10 cm in the transverse direction (TD). Each specimen is completely immersed for 5 seconds in a 90° C. water bath (or other specified nonreactive liquid). The distance between the ends of the shrunken specimen is measured. The difference in the measured distance for the shrunken specimen and the original 10 cm is multiplied by 10 to obtain the percent of shrinkage for the specimen for each direction. The MD shrinkage for the 4 specimens is averaged for the machine direction Shrink Value of the given film sample, and the TD shrinkage for the 4 specimens is averaged for the transverse direction Shrink Value.

Minimal Shrink Values of the polyethylene-based packaging film may contribute towards high quality printed indicia or graphics of the film. Non-limiting examples include (a) printed indicia on the outer surface of the polyethylene-based packaging film, which may be optionally corona-treated or (b) reverse printed indicia on the first surface of the third region, which may be optionally corona-treated.

### Packages

The polyethylene-based packaging film of the present disclosure may be formed into a package. The package may take any number of forms not limited to stand-up pouches, quad-seal bags, pillow packs or pouches, sachets, flow wrap, etc. The packages include at least a sidewall of the polyethylene-based packaging film. The sidewall is sealed by a seal to form a package body that can contain a product.

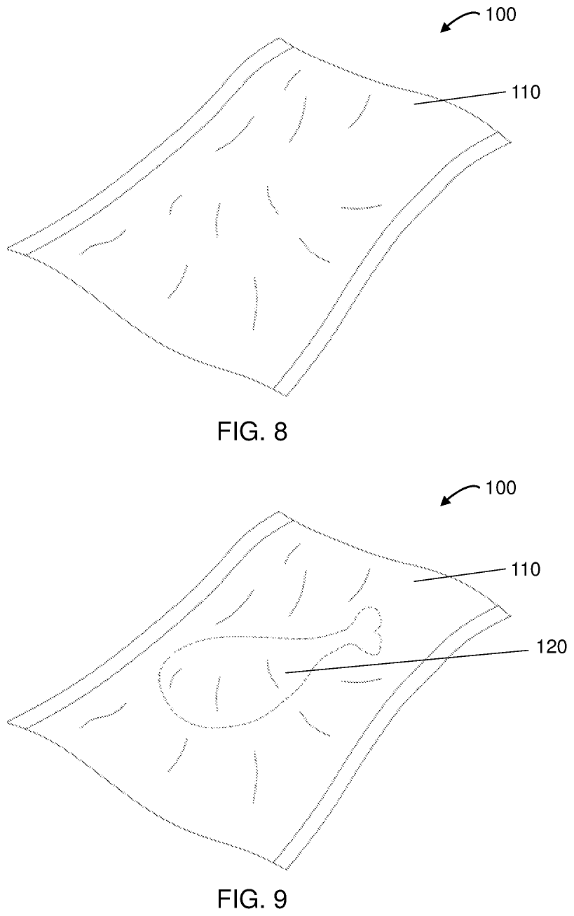

The packages may be produced with additional features or components such as tear lines, tear notches, and mechanical closures (e.g., hook and loop, press and close, zipper). These features may facilitate easy opening and reclosing of the package after the initial opening. With reference to FIG. 8 and FIG. 9, a package 100 is shown. The package 100 is formed from a polyethylene-based packaging film 110 as described herein. The polyethylene-based packaging film is sealed to itself or any other packaging component to form a package for enclosing a product. A product 120 is shown in FIG. 9 that is enclosed in the package 100 shown in FIG. 8.

The product may be any type of consumer or industrial item, medical product, pharmaceutical item, food item, or non-food item. The product in the package may include a solid, a liquid, a semi-solid product, or a combination thereof. Non-limiting examples include a personal care product, a food, a pet food, a medical product, a pharmaceutical product, a first aid product, a nutritional aid product, or a beverage.

The packages disclosed herein may be suitable for recycling. As used herein, the terms “suitable for recycling” and “recyclable” refer to treatment of or processes applied to used materials to make the materials suitable for reuse. In some instances, recyclable is intended to reflect that the material can be easily processed in a recycling process that accepts “all-polyethylene” articles or “all-polyolefin” articles. In other instances, recyclable is intended to reflect that the material meets recycled content standards established by organizations (e.g., The Association of Plastic Recycling or Recycled Material Standard). Typically, these recycling processes can accept low levels of some contaminant material. As such, recyclable further reflects the polyethylene-based packaging film having very high levels of polyethylene and low levels of acceptable contaminates. The total composition defined by weight of materials defines the recyclability of the packaging film. As described herein, the “total composition” of the package refers to all components and materials, including, for example, the sidewall, patch, zipper, and any other additional components. The total composition of the package may include between 90% and 99% polyethylene-based polymer, by weight. In some embodiments, the total composition of the package is greater than 90%, or greater than 95% polyethylene-based polymer, by weight. In some other embodiments, the packages may include a total composition including at least 95% polyethylene-based polymer, by weight. That is, the package including the polyethylene-based packaging film and any additional features or components may be a polyethylene-based package or a polyethylene-rich package.

### Fabrication

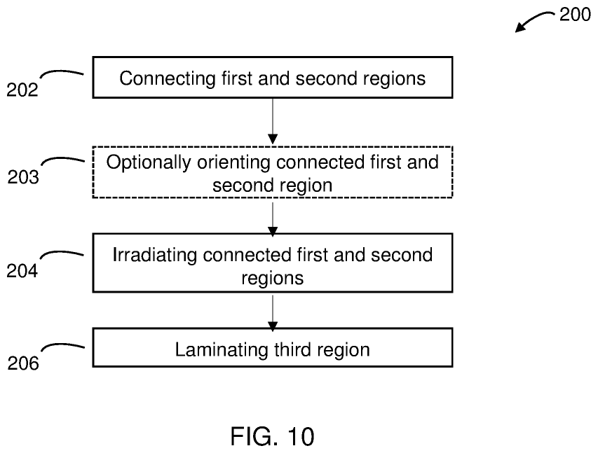

A method of making a polyethylene-based packaging film that includes a first region, a second region, and a third region is disclosed herein. With reference to FIG. 10, a method 200 of making the polyethylene-based packaging film is shown.

At operation 202 of method 200, a first region is connected with a second region to form a connected first region and second region. In some embodiments, the first region and the second region are connected by coextrusion. In one or more embodiments, the first region includes a first polyethylene and the second region includes a second polyethylene and an antioxidant. In one or more embodiments, the connected first region and second region has a thickness ratio of the first region thickness to the second region thickness in a range of from 1:99 to 50:50.

At operation 204 of method 200, the connected first region and second region is irradiated with an electron beam treatment (e.g., E-beam (EB)). Treatment takes place on each of the exposed surfaces of the connected first region and second region that may occur simultaneously. In one or more embodiments, the EB treatment dosage includes from about 6 Megarads (Mrad) to about 15 Mrad, or any value therebetween. In an embodiment, the EB treatment dosage is from equal to or greater than 6 Mrad. As the entire connected first region and second region is exposed to the EB treatment, the unique structure of the connected first region and second region localizes cross-linking to take place in the first region while minimizing cross-linking in the second region. This is especially advantageous for heat resistance of the polyethylene-based packaging film because the outer surface of the film that includes the first region is directly exposed to a heat bar or heat sealing mechanism during fabrication of a package.

At operation 206 of method 200, the irradiated connected first region and second region is laminated to the third region. In one or more embodiments, the second region is laminated to the third region. The third region may include a sealant film.

Optionally, the connected first region and second region may undergo orienting at operation 203 of method 200 by methods understood in the art. In one or more embodiments, orienting of the connected first region and second region takes place before irradiating the connected first region and second region. The resulting oriented film of the connected first region and second region may be a monoaxially oriented film or a biaxially oriented film.

A surface of the first region, the second region, or the third region may receive printed indicia. The surface may be corona-treated prior to receiving printed indicia.

The polyethylene-based packaging film comprises a gel content from less than 3% according to test method ASTM D2765-01, Method C.

To form a package, a sealant surface of the polyethylene-based packaging film is adhered to itself or another film to form a seam (e.g., seal) of a sidewall.

### EXAMPLES

Various embodiments will be further clarified by the following examples.

### Examples 1-6

Coextruded Film Gel Content: Gel content of coextruded films without added antioxidant and that were exposed to different irradiation levels were evaluated to understand the effect of irradiation on gel formation. The coextruded films were produced with two layers having the following structure: HDPE/MDPE/HDPE. The film thickness was 25.4 micron with a layer thickness ratio of 15:70:15. The coextruded films were machine direction oriented (level of orientation was 5.5) and each film was exposed to a different level of irradiation. Each of the coextruded films was measured for gel content according to test method ASTM D2765-01, Method C. The coextruded film samples and gel content results are summarized in TABLE 1.

The results indicate that lower doses of irradiation maintain low gel content that is indicative of ease of recyclability.

TABLE 1

| Coextruded | Irradiation | Gel |
|---|---|---|
| Film | Level | Content |
| Sample | (Mrad) | (%) |
| Example 1 | 0 | 0.2 |
| Example 2 | 1 | 0.2 |
| Example 3 | 3 | 8.3 |
| Example 4 | 5 | 18.5 |
| Example 5 | 7 | 73.7 |
| Example 6 | 9 | 72.2 |

Coextruded Film Heat resistance: Coextruded Film Examples 1, 3, and 6 from the Coextruded Film Gel Content evaluation were used for the heat resistance evaluation. The HDPE layer is representative of a package outer package surface that is exposed to heat sealing equipment upon package fabrication.

Heat resistance was measured by placing the coextruded film against a heated metal seal jaw (without non-stick coating e.g., TEFLON coating) with the HDPE layer facing upward. An initial seal test temperature was about 93° C. (200° F.) at a pressure of about 0.207 MPa (30 psi) and dwell time of 0.5 second. The temperature was increased in increments of about 9° C. (15° F.), while keeping the pressure and the dwell time constant. The laminated film was visually inspected after each increment in temperature. Five stages of visual inspection, along with the corresponding rating for each stage, are shown in TABLE 2.

TABLE 2

| Visual Inspection Stage | Rating |
|---|---|
| No / negligible distortion | 0 |
| Slight distortion | 1 |
| Medium distortion | 2 |
| High distortion | 3 |
| Destruction | 4 |

The visual inspection results for Coextruded Film Examples 1, 3, and 6 are shown in TABLE 3.

TABLE 3

| | ° C. | | | | | | | |
|---|---|---|---|---|---|---|---|---|
| | 93.3 | 101.7 | 110.0 | 121.1 | 126.7 | 135.0 | 143.3 | 151.6 |
| | ° F. | | | | | | | |
| Sample | 200.0 | 215.0 | 230.0 | 245.0 | 260.0 | 275.0 | 290.0 | 305.0 |
| Example 1 | 0 | 0 | 1 | 2 | 3 | 4 | 4 | 4 |
| Example 3 | 0 | 0 | 0 | 1 | 2 | 3 | 4 | 4 |
| Example 6 | 0 | 0 | 0 | 1 | 1 | 2 | 2 | 3 |

The heat resistance of Example 3 includes heat resistance improvement where slight film distortion begins with respect to Example 1. Example 6 includes heat resistance improvement where slight film distortion begins with respect to Example 1. It is noted that the gel content of Example 1 may be conducive to easily recyclable films and the gel content of Example 6 is much greater than the gel content of Example 1.

The results indicate that higher irradiation levels improve the heat resistance of the coextruded films that can be extrapolated to laminated film structures. However, films with high gel content are difficult to recycle. The effect of added antioxidant is observed to lower gel content.

### Prophetic Examples 1A-1C, 2A-2C, 3A-3C, 4A4-C, 5A-5C, 6A-6C

The following prophetic Examples 1A-1 C, 2A-2C, 3A-3C, 4A-4C, 5A-5C, 6A-6C show an effect of laminating each of the coextruded films of Examples 1-6 to a sealant film, which is that gel content is diluted. Thicker sealant films dilute gel content more than thinner sealant films. Three types of sealant films were analyzed: Film “A” has a thickness of 50.8 micron (2.0 mil); Film “B” has a thickness of 76.3 micron (3.0 mil); and Film “C” has a thickness of 127 micron (5.0 mil). Example 1A is a combination of Film A and the coextruded film of Example 1; Example 1B is a combination of Film B and the coextruded film of Example 1; and Example 1C is a combination of Film C and the coextruded film of Example 1. Examples 2A-2C, 3A-3C, 4A-4C, 5A-5C, and 6A-6C are analogously constructed. The gel content is shown in TABLE 4.

TABLE 4

| | Prophetic Laminated Films | | |
|---|---|---|---|
| | “A” | “B” | “C” |
| | 50.8 micron | 76.2 micron | 127 micron |
| | gel content (%) | gel content (%) | gel content (%) |
| Examples | 0.07 | 0.05 | 0.03 |
| 1A-1C | | | |
| Examples | 0.07 | 0.05 | 0.03 |
| 2A-2C | | | |
| Examples | 2.8 | 2.08 | 1.38 |
| 3A-3C | | | |
| Examples | 6.2 | 4.6 | 3.1 |
| 4A-4C | | | |
| Examples | 24.6 | 18.4 | 12.3 |
| 5A-5C | | | |
| Examples | 24.0 | 18.0 | 12.0 |
| 6A-6C | | | |

The prophetic laminated film Example 1A that includes the coextruded film of Example 1 (thickness of 25.4 micron (1.0 mil)) laminated to sealant Film “A”, effectively has the gel content reduced by a factor of 3 that is based on the laminated film thickness (i.e., 0.2% divided by 3 equals 0.07%). The prophetic laminated film Example 2B that includes the coextruded film of Example 2 (thickness of 25.4 micron (1.0 mil)) laminated to sealant Film “B”, effectively has the gel content reduced by a factor of 3 that is based on the laminated film thickness (i.e., 0.2% divided by 4 equals 0.05%). The prophetic laminated film Example 3C that includes the coextruded film of Example 1 (thickness of 25.4 micron (1.0 mil)) laminated to sealant Film “C”, effectively has the gel content reduced by a factor of 5 that is based on the laminated film thickness (i.e., 8.3% divided by 6 equals 1.38%). The other prophetic laminated film examples were analogously calculated.

### Examples 7-9 and Comparative Example A

Laminated Film Sample Gel Content: The following steps were used in the fabrication process of Examples 7-9 films. A resin or resin blend corresponding to each layer was extruded through a die and the layers were coextruded. Coextruded blown films were machine direction oriented (MDO) and irradiated with different EB treatment dosages. The coextruded blown films were laminated to a sealant film.

The coextruded film layers included: HDPE/MDPE+antioxidant/HDPE. The thickness ratio of the HDPE layers thickness to the MDPE+antioxidant layer thickness ratio was 15:70:15. The thickness of the coextruded film was 25.4 micron (1.0 mil). Level of orientation was from 4.5 to 7.0. Each of the coextruded films were irradiated at greater than 6 Mrad in a range of from 7 Mrad to 15 Mrad. Each example film was made with a different added antioxidant and a different amount of added antioxidant. The added antioxidant and amount of added antioxidant are shown in TABLE 5.

The fabrication of Comparative Example A coextruded film differed from the coextruded film of Examples 7-9 in that no added antioxidant was included and that the film was not irradiated.

Comparative Example A and Examples 7-9 coextruded films were laminated to a sealant film to produce a laminated film. The sealant film layers included MDPE+LLDPE/LLDPE/mLLDPE. The sealant film thickness was 50.8 micron (2.0 mil) with each layer of the sealant film prepared in the following proportion of the sealant film total thickness: 25:50:25. The lamination means was solventless adhesive lamination.

Each of the laminated films, Examples 7-9 and Comparative Example A, was measured for gel content according to test method ASTM D2765-01, Method C. Examples 7-9 included gel content less than 3%. Comparative Example 1 included gel content greater than 3%.

TABLE 5

| Laminated Film | | Minimum Amount | |
|---|---|---|---|
| Samples | | of Antioxidant, | |
| Designated by | | weight %, to | |
| Coextruded Film | Antioxidant | Reduce gel | Gel |
| Example Number | Type | content to <3% | Content |
| Example 7 | POLYBATCH | 2.4 | <3% |
| | XAO 25B and | | |
| | HOSTANOX | | |
| | Secondary | | |
| Example 8 | POLYBATCH | 1.9 | <3% |
| | XAO 25B | | |
| Example 9 | HOSTANOX | 3.8 | <3% |
| | Primary | | |
| Comparative | No | No | >3% |
| Example A | antioxidant | antioxidant | |

The above description and examples illustrate certain embodiments of the present disclosure and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present invention.

1. A polyethylene-based packaging film having an outer surface and an inner surface, the polyethylene-based packaging film comprising:
an oriented coextruded film comprising a first region connected to a second region, the first region comprising a first polyethylene, having a first region thickness, and forming the outer surface of the polyethylene-based packaging film; the second region comprising a second polyethylene and an antioxidant, and having a second region thickness;
a third region being laminated to the second region and comprising a sealant film; a thickness ratio of the first region thickness to the second region thickness in a range of from 1:99 to 50:50; and a gel content of less than 3% according to test method ASTM D2765-01, Method C.

2. The polyethylene-based packaging film of claim 1, wherein the first region and the second region are connected directly to each other.

3. The polyethylene-based packaging film of claim 1, wherein a tie layer is positioned between the first region and the second region.

4. The polyethylene-based packaging film of claim 1, wherein the first region and the second region comprise a biaxially oriented film.

5. The polyethylene-based packaging film of claim 1, wherein the first region and the second region comprise a monoaxially oriented film.

6. The polyethylene-based packaging film of claim 1, wherein the antioxidant is present in an amount from 1.5% to 5.0%, by weight of the polyethylene-based packaging film.

7. The polyethylene-based packaging film of claim 1, wherein the second region comprises a multilayer coextruded film.

8. The polyethylene-based packaging film of claim 1, wherein the first polyethylene comprises polyethylene homopolymers, ethylene copolymers, alpha-olefin polyethylene copolymer, or blends thereof.

9. The polyethylene-based packaging film of claim 1, wherein the first polyethylene comprises high density polyethylene (HDPE).

10. The polyethylene-based packaging film of claim 1, wherein the second polyethylene comprises polyethylene homopolymers, ethylene copolymers, alpha-olefin polyethylene copolymer, cyclic olefin copolymer, or blends thereof.

11. The polyethylene-based packaging film of claim 1, wherein the first antioxidant comprises a primary antioxidant, a secondary antioxidant, or a combination thereof.

12. The polyethylene-based packaging film of claim 1, further comprising a thermal resistance from 127 degrees Celsius (° C.) (260 degrees Fahrenheit (° F.)) to 152° C. (305° F.).

13. The polyethylene-based packaging film of claim 1, further comprising a Shrinkage Value of 10% or less upon application of heat equal to 90° C.

14. The polyethylene-based packaging film of claim 1, wherein the polyethylene-based packaging film is a polyethene-rich packaging film.

15. A package comprising the polyethylene-based packaging film of claim 1.

16. A polyethylene-based packaging film having an outer surface and an inner surface, the polyethylene-based packaging film comprising:
an oriented coextruded film comprising a first region connected to a second region, the first region comprising a first polyethylene comprising a cyclic olefin copolymer, having a first region thickness, and forming the outer surface of the polyethylene-based packaging film; the second region comprising a second polyethylene and an antioxidant, and having a second region thickness; a third region being laminated to the second region and comprising a sealant film; a thickness ratio of the first region thickness to the second region thickness in a range of from 1:99 to 50:50; and a gel content of less than 3% according to test method ASTM D2765-01, Method C.

17. The polyethylene-based packaging film of claim 16, wherein the second polyethylene comprises polyethylene homopolymers, ethylene copolymers, alpha-olefin polyethylene copolymer, cyclic olefin copolymer, or blends thereof.

18. The polyethylene-based packaging film of claim 16, further comprising a thermal resistance from 127 degrees Celsius (° C.) (260 degrees Fahrenheit (° F.)) to 152 degrees Celsius (° C.) (305 degrees Fahrenheit (° F.)).

19. A method of making a polyethylene-based packaging film having an exposed surface and an inner surface, the method comprising:
connecting a first region comprising a first polyethylene and having a first region thickness with a second region comprising a second polyethylene and an antioxidant and having a second region thickness to form a connected first region and second region;
irradiating the connected first region and second region with a dosage from equal to or greater than 6 Mrad; and
laminating the second region to a third region positioning the first region as the exposed surface of the polyethylene-based packaging film,
wherein the polyethylene-based packaging film comprises a thickness ratio of the first region thickness to the second thickness region in a range of from 1:99 to 50:50, and a gel content of less than 3% according to test method ASTM D2765-01, Method C.

20. The method according to claim 19, further comprising orienting the connected first region and second region before the irradiating step.
